(19) United States
(12) Patent Application Publication
(10) Pub. No.: US 2015/0281787 A1
(43) Pub. Date: Oct. 1, 2015

(54) Social Network Augmentation of Broadcast Media

(71) Applicant: Google Inc., Mountain View, CA (US)

(72) Inventor: Ranjith Jayaram, San Jose, CA (US)

(73) Assignee: Google Inc., Mountain View, CA (US)

(21) Appl. No.: 14/214,861

(22) Filed: Mar. 15, 2014

Related U.S. Application Data
(60) Provisional application No. 61/800,562, filed on Mar. 15, 2013.

(51) Int. Cl. H04N 21/4722; H04N 21/4788; H04N 21/462; H04N 21/431; H04N 21/435

(52) U.S. Cl. CPC H04N 21/4722; H04N 21/4312; H04N 21/435; H04N 21/4622; H04N 21/4788

(57) ABSTRACT

Systems, methods and devices described herein enable users of Internet-enabled devices to view and access various Internet-based media applications and services associated with broadcast media programs in real-time. For example, in some implementations systems, methods and devices are operable to synchronize the user interface of a client device with the real-time broadcast of a particular broadcast media program. In turn, the device is enabled to receive entity metadata associated with at least one identifiable entity included in the particular broadcast media program. The entity metadata includes at least one of instructions or a pointer that enables access to at least one media application or service associated with the at least one identifiable entity. The device then presents the availability of access to the at least one media application or service associated with the particular broadcast media program to the user via the user interface of the client device in real-time.

### RELATED APPLICATIONS

This application claims priority to U.S. Provisional Patent Application No. 61/800,562, filed Mar. 15, 2013, entitled “Social Network Augmentation of Broadcast Media,” which is incorporated by reference herein in its entirety.

### TECHNICAL FIELD

The present disclosure generally relates to linking Internet-based applications and services to broadcast media programs, and in particular, to providing users with real-time access to associated applications and services while a broadcast media program is playing.

### BACKGROUND

Users of Internet-enabled electronic devices are increasingly interested in real-time access to Internet-based media applications and services associated with broadcast media programs (e.g. TV programs, sports events, pay-per-view events and movies, etc.). Currently, however, it is relatively cumbersome for a user to find and access related media applications and services associated with a broadcast media program in real-time. Some users are deterred by the effort it takes to find and access Internet-based applications and services associated with broadcast media programs.

The current methods of discovering and accessing online applications and services are primarily user-driven. At the outset, discovering applications and/or services associated with a broadcast media program currently requires users to take some action beyond the viewing experience to find the associated content, such as a keyword search using an Internet search engine. A user-driven search generally tends to be ad hoc, and often produces incomplete search results. A user-driven search can also lead a particular user astray to topics and/or content providers that are unrelated or only tangentially related to the broadcast media program. Consequently, an opportunity to further engage that particular user has been lost along with an opportunity to monetize the Internet-based user engagement.

The users also lose out. For example, it is difficult for a casual viewer to determine public or community opinion about a particular subject that is occurring in real-time (e.g. a televised political debate). Typically, users have to seek out various content publishers that post content about the subject, including source-synchronous and quasi-officially approved posts from producers, cast members and/or other program representatives. It can be time consuming to decipher public or community opinion about the subject from ratings, articles and/or comments posted on websites or micro-blogging applications. For example, in the case of a TV program, the total amount of Internet searching involved may take longer than the duration of the TV program, which makes trying to determine public or community opinion about the TV program in real-time a futile endeavor. In another example, users that are led astray may simply overlook related applications and/or services provided by the content provider responsible for broadcast media program.

### SUMMARY

Systems, methods and devices described herein enable users of Internet-enabled devices to access various Internet-based media applications and services associated with broadcast media programs in real-time. Features of various implementations enable users of Internet-enabled devices to view and access various Internet-based media applications and services associated with a broadcast media program in real-time. For example, in some implementations systems, methods and devices are operable to synchronize the user interface of a client device with the real-time broadcast of a particular broadcast media program. In turn, the device is enabled to receive entity metadata associated with at least one identifiable entity included in the particular broadcast media program. The entity metadata includes at least one of instructions or a pointer that enables access to at least one media application or service associated with the at least one identifiable entity. The client device then presents the availability of access to the at least one media application or service associated with the particular broadcast media program to the user via the user interface of the client device in real-time.

One aspect of the disclosure is a system enabling device interaction with media services associated with identifiable entities within a broadcast media program. In some implementations, the system includes instructions, storable in a non-transitory memory and executable by a processor, that, when executed by a processor, cause a device to: match the user interface of a user device with a particular broadcast media program having at least one identifiable entity; receive entity metadata associated with the at least one identifiable entity, wherein the entity metadata includes at least one of instructions or a pointer that enables access to at least one media service associated with the at least one identifiable entity; and present the availability of access to the at least one media service associated with the at least one identifiable entity.

In some implementations, the system further comprises instructions that, when executed by the processor, cause the device to receive a user input, wherein the input is indicative of at least the initiation of attempting to access media services associated with the particular broadcast media program, and wherein the instructions to match the user interface with the particular broadcast media program are processed in response to receiving the user input. In some implementations, the system further comprises instructions that, when executed by the processor, cause the device to receive a user input, wherein the input is indicative of at least the initiation of attempting to access media services associated with the particular broadcast media program, and wherein the instructions to present the availability of access to the at least one media service are processed in response to receiving the user input.

In some implementations, the system further comprises instructions that, when executed by the processor, cause the device to transmit a user selection associated with the at least one media service presented on a user interface. In some implementations, the system further comprises instructions that, when executed by the processor, cause the device to transmit a request for updated entity metadata.

In some implementations, wherein the particular broadcast media program includes at least one of a movie, a television show, a commercial, radio show, a video file, or an audio file. In some implementations, wherein the at least one identifiable entity includes a person, a place, an object or an indicia of a service. In some implementations, wherein the object includes a consumer product. In some implementations, wherein the service includes at least one of an internet-based service or an action by a service provider. In some implementations, wherein the at least one media service includes one of electronic mail, a website, a social networking service, or a telephone service. In some implementations, wherein the device comprises a client device associated with a television, and the entity metadata is presented as a screen overlay. In some implementations, wherein the device comprises a television, and the entity metadata is presented as a screen overlay. In some implementations, wherein the device comprises at least one of a laptop computer, a tablet computer or a smart phone, and the entity metadata is presented in a web-browser. In some implementations, wherein the device comprises at least one of a laptop computer, a tablet computer or a smart phone, and the entity metadata is presented in an application interface. In some implementations, wherein the entity metadata comprises a dataset that includes the dataset comprising the broadcast media content. In some implementations, wherein the entity metadata comprises a dataset that is distinct from the dataset comprising the broadcast media content. In some implementations, wherein the entity metadata includes relationship information linking at least two entities.

One aspect of the disclosure is a computer-implemented method of enabling interaction with media services associated with identifiable entities within a broadcast media program from a device including a non-transitory memory and a processor. In some implementations, the method includes aggregating entity metadata associated with one or more identifiable entities within the broadcast media program, wherein the entity metadata includes at least one of instructions or a pointer that enables access to at least one media service associated with the at least one identifiable entity; providing an interface by which users can request presentation of the entity metadata; and facilitating access to at least one media service associated with the at least one identifiable entity in response to receiving a request from a user device.

### BRIEF DESCRIPTION OF THE DRAWINGS

So that the present disclosure can be understood in greater detail, a more particular description may be had by reference to the features of various implementations, some of which are illustrated in the appended drawings. The drawings, however, illustrate only certain typical features of the present disclosure and are therefore not to be considered limiting, for the description may admit to other effective features.

FIG. 1 is a block diagram of an example client-server environment.

FIG. 2 is a block diagram of another example client-server environment.

FIG. 3A is a block diagram of an example data structure linking broadcast media program content data with metadata including links to related Internet-based applications and/or services.

FIG. 3B is a block diagram of an another example data structure linking broadcast media program content data with metadata including links to related Internet-based applications and/or services.

FIG. 4A is a block diagram of an example application program interface linking broadcast media program content data with metadata including links to related Internet-based applications and/or services.

FIG. 4B is a block diagram of an another example application program interface linking broadcast media program content data with metadata including links to related Internet-based applications and/or services.

FIG. 5 is a flowchart representation of a client device method.

FIG. 6 is a flowchart representation of a client device method.

FIG. 7 is a flowchart representation of a client device method.

FIG. 8 is a flowchart representation of a server system method.

In accordance with common practice the various features illustrated in the drawings may not be drawn to scale. The dimensions of the various features may be arbitrarily expanded or reduced for clarity. Some of the drawings may not depict all of the components of a given system, method or device. Finally, like reference numerals may be used to denote like features throughout the specification and figures.

### DETAILED DESCRIPTION

Systems, methods and devices described herein enable users of Internet-enabled devices to access various Internet-based media services associated with broadcast media programs in real-time. In other words, the various implementations enable bridging the use of Internet-based applications and services with the viewing and/or listening experiences associated with broadcast media, such as television and radio.

For example, a client device is enabled to synchronize a displayable user interface with a real-time broadcast of a particular broadcast media program having at least one identifiable entity, such as a person, a place, an object or an indicia of a service. In turn, the device is enabled to receive entity metadata associated with the at least one identifiable entity. The entity metadata includes at least one of instructions or a pointer that enables access to at least one Internet-based media application or service associated with the at least one identifiable entity or the broadcast media program generally. Then, based at least on the particular broadcast media program, the device is enabled to present the availability of access to the at least one media application or service to the user on the displayable user interface.

Numerous details are described herein in order to provide a thorough understanding of the example implementations illustrated in the accompanying drawings. The invention may be practiced without these specific details. Well-known methods, procedures, components, and circuits have not been described in exhaustive detail so as not to unnecessarily obscure more pertinent aspects of the example implementations.

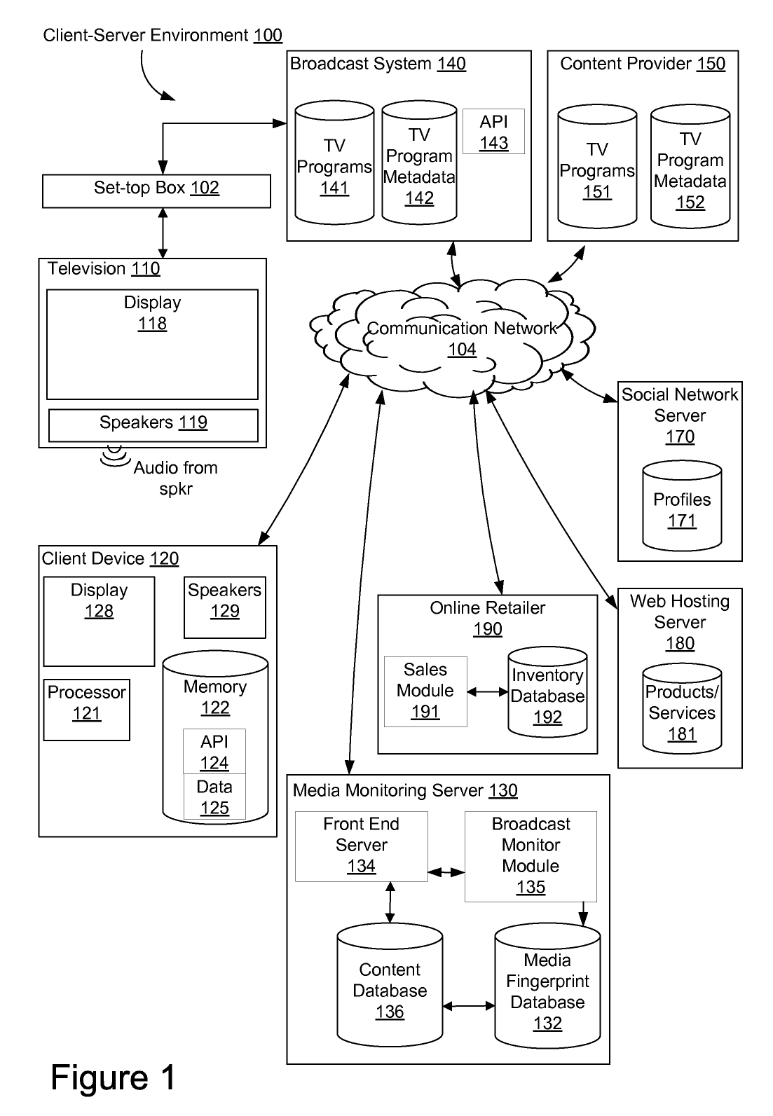

FIG. 1 is a block diagram of an example client-server environment 100. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes a set-top box 102, a television (TV) 110, a second screen client device 120 (e.g. a laptop, a tablet computer, smartphone, etc.), a communication network 104, a media monitoring server 130, a broadcast system 140, a content provider 150, a social network server 170, a web hosting server, and an online retailer 190. The second screen client device 120, the media monitoring server 130, the broadcast system 140, the content provider 150, and the social network server 170, a web hosting server, and an online retailer 190 are capable of being connected to the communication network 104 in order to exchange information with one another and/or other devices and systems. The client-server environment 100 is merely an example provided to discuss more pertinent features of the present disclosure. Those skilled in the art will appreciate from the present disclosure that any number of such devices and/or systems may be provided in a client-server environment, and other devices may be altogether absent.

In some implementations, the media monitoring server 130 is implemented as a single server system, while in other implementations it is implemented as a distributed system of multiple servers. For convenience of explanation, the media monitoring server 130 is described below as being implemented on a single server system. Similarly, in some implementations, the social network server 170 is implemented as a single server system, while in other implementations it is implemented as a distributed system of multiple servers. Solely, for convenience of explanation, the social network server 170 is described below as being implemented on a single server system. Similarly, in some implementations, the web hosting server 180 is implemented as a single server system, while in other implementations it is implemented as a distributed system of multiple servers. For convenience of explanation, the web hosting server 180 is described below as being implemented on a single server system. Similarly, in some implementations, the broadcast system 140 is implemented as a single server system, while in other implementations it is implemented as a distributed system of multiple servers. For convenience of explanation, the broadcast system 140 is described below as being implemented on a single server system. Similarly, in some implementations, the content provider 150 is implemented as a single server system, while in other implementations it is implemented as a distributed system of multiple servers. For convenience of explanation, the content provider 150 is described below as being implemented on a single server system. Moreover, the functionality of the broadcast system 140 and the content provider 150 can be combined into a single server system. Additionally and/or alternatively, while only one broadcast system and only one content provider is illustrated in FIG. 1 for the sake of brevity, those skilled in the art will appreciate from the present disclosure that fewer or more of each may be present in an implementation of a client-server environment.

In some implementations, the set-top box 102 and the TV 110 are provided in combination. The set-top box 102 is configured to receive and decode signals including media content from the broadcast system 140 or the like. In some implementations, the set-top box 102 is also Internet-enabled in order to receive signals including media content or the like. In operation, the set-top box 102 decodes the signal received from the broadcast system 140 or the like and provides audio and video content to the TV 110 for display. While a TV has been used in the illustrated example, those skilled in the art will appreciate from the present disclosure that any number of displays devices, including computers, laptop computers, tablet computers, smart-phones and the like, can be used to display a video stream and play the associated audio stream. In some implementations, the functions of the set-top box 102 and the TV 110 may be combined into a single device.

In some implementations, the set-top box 102 is any computer device capable of connecting to the communication network 104, receiving video streams, extracting information from video streams and presenting video streams for the display using the TV 110 (or another display device). In some implementations, the set-top box 102 may be configured as a receiver for cable TV and/or satellite TV, a digital video recorder (DVR), a digital media receiver, a TV tuner, a computer, and/or any other device that outputs TV signals. In some implementations the TV 110 can be a conventional TV display that is not connectable to the Internet and that displays digital and/or analog TV content received via over the air broadcasts or a satellite or cable connection.

As is typical of televisions, the TV 110 includes a display 118 and speakers 119. Additionally and/or alternatively, the TV 110 can be replaced with another type of display device for presenting video content to a user, such as for example, a computer, a tablet device, a mobile telephone, a projector, or other type of video display system. The display device can be coupled to the set-top box 102 via a wireless or wired connection.

As used herein, a TV signal is an electrical, optical, or other type of data transmitting medium that includes audio and/or video components corresponding to a TV channel. In some implementations, the TV signal is a terrestrial over-the-air TV broadcast signal or a sign distributed/broadcast on a cable-system or a satellite system. In some implementations, the TV signal is transmitted as data over a network. For example, the set-top box 102 can receive video streams from an Internet connection. Audio and video components of a TV signal are sometimes referred to herein as audio signals and video signals. In some implementations, a TV signal corresponds to a TV channel that is being displayed on the TV 110.

The second screen client device 120 may be any computer device that is capable of connecting to the communication network 104, such as a computer, a laptop computer, a tablet device, a netbook, an Internet kiosk, a personal digital assistant, a mobile phone, a gaming device, or any other device that is capable of communicating over the communication network 104. In some implementations, the second screen client device 120 includes one or more processors 121, non-volatile memory 122 such as a hard disk drive, a display 128, speakers 129, and various other notoriously well known components that are not shown for the sake of brevity. The second screen client device 120 may also have input devices such as a keyboard, a mouse and/or track-pad (not shown). In some implementations, the second screen client device 120 includes a touch screen display, a digital camera and/or any number of well known supplemental devices to add functionality.

In some implementations, the second screen client device 120 may be connected to the set-top box 102 via a wireless or wired connection. In some implementations, the second screen client device 120 may optionally operate in accordance with instructions, information and/or digital content (collectively “second screen information”) provided by the set-top box 102 (and vice versa). In some implementations, the set-top box 102 issues instructions to the second screen client device 120 that causes the second screen client device 120 to display the real-time availability of Internet-based media applications or services associated with the currently playing broadcast media program.

In some implementations, the second screen client device 120 includes a microphone that enables the client device to receive sound (audio content) from, for example, the speakers 119 of the TV 110. The microphone enables the second screen client device 120 to store the audio content/soundtrack that is associated with the video content as it is presented. The second screen client device 120 is enabled to store this information locally and then send an associated server system content information that is any one or more of: fingerprints of the stored audio content, the audio content itself, portions/snippets of the audio content, fingerprints of the portions of the audio content or references to the playing content.

In turn, the associated server system (e.g. a media monitoring server operable to monitor the broadcast system 140) can identify the content playing on the television even if the electronic device on which the content is being presented is not an Internet-enabled device (e.g. as an older TV set) or is not currently connected to the Internet. Such an arrangement (i.e., where the second screen client device 120 stores and sends the content information to the media monitoring server 130) allows a user to receive one or more Internet-based media applications and/or services associated with the real-time broadcast of a TV program or the like.

In some implementations, the second screen client device 120 includes one or more applications 125 stored in the memory 122. As discussed in greater detail below, the processor 121 executes the one or more applications in accordance with a set of instructions received from the web-hosting server 180, the broadcasting system 140 and/or the content provider 140.

The communication network 104 may be any combination of a wired and a wireless local area network (LAN) and/or wide area network (WAN), such as an intranet, an extranet, including a portion of the Internet, or a wireless network provided by a wireless carrier. In some implementations, the communication network 104 uses the HyperText Transport Protocol (HTTP) to transport information using the Transmission Control Protocol/Internet Protocol (TCP/IP). HTTP permits the client device 120 to access various resources available via the communication network 104. But the various implementations described herein are not limited to the use of any particular protocol.

In some implementations, the media monitoring server 130 includes a front end server 134 that facilitates communication between the media monitoring server 130 and the communication network 104. The front end server 134 receives content information from the second screen client device 120. In some implementations, the content information is a video stream, a portion thereof, and/or a reference to a portion thereof. A reference to a portion of a video stream may include a time indicator and/or a digital marker referencing the content of the video stream. In some implementations, the content information is derived from a video stream being presented (i.e. playing) by the combination of the TV 110 and the set-top box 102.

In some implementations, the front end server 134 is configured to send a set of instructions to the second screen client device 120. In some implementations, the front end server 134 is configured to send content files, links to content files and/or metadata associated with the content files. The term “content file” includes any document or content of any format including, but not limited to, a video file, an image file, a music file, a web page, an email message, an SMS message, a content feed, an advertisement, a coupon, a playlist or an XML document. In some implementations, the front end server 134 is configured to send or receive one or more video streams. In some implementations, the front end server 134 is configured to receive content directly from the broadcast system 140 and/or the content provider 150 over the communication network 104.

In some implementations, the media monitoring server 130 includes a broadcast monitor module 135 that is configured receive and record broadcast media programming as the broadcast media programming airs, and to create fingerprints of media content broadcast by the broadcast system 140 and/or the content provider 150. In some implementations, the media monitoring server 130 includes a fingerprint database 132 that stores content fingerprints. A content fingerprint includes any type of condensed or compact representation, or signature, of the content of a video stream and/or audio stream. In some implementations, a fingerprint may represent a clip (such as several seconds, minutes, or hours) of a video stream or audio stream. Or, a fingerprint may represent a single instant of a video stream or audio stream (e.g., a fingerprint of single frame of a video or of the audio associated with that frame of video). Furthermore, since video content may change over time, corresponding fingerprints of that video content may also change over time. In some implementations, the fingerprint database 132 is a distributed database.

In some implementations, the media monitoring server 130 includes a content database 136. In some implementations, the content database 136 includes advertisements, videos, images, music, web pages, email messages, SMS messages, content feeds, advertisements, coupons, playlists, XML documents, and ratings associated with various media content or any combination thereof. In some implementations, the content database 136 includes links to advertisements, videos, images, music, web pages, email messages, SMS messages, content feeds, advertisements, coupons, playlists, XML documents and ratings associated with various media content. In some implementations, the content database 136 is a distributed database.

In some implementations, the broadcast system 140 includes media content such as TV programs 141. In other words, the broadcast system 140 includes electronic copies of the media content. In some implementations, the broadcast system 140 also includes metadata 142 associated with one or more of the TV programs 141, and application program interface instructions 143. In some implementations, the application program interface instructions 143 include instructions that can be provided to a client device and/or may be executed by the broadcast system 140 under a client-server model or the like. In some implementations, the instructions link a particular TV program 141 with the associated metadata 142 and/or link the TV program 141 and the associated metadata 142 with external data and/or services, such as a social networking application. In some implementations, the content provider 150 includes media content such as TV programs 151, as well as metadata 152 associated with one or more of the TV programs 151.

In some implementations, the social network server 170 includes profiles 171, which include profiles of users, brands, companies and/or groups. In some implementations, the web hosting server 180 includes a content database 181 that includes, for example, various web pages, Internet-based applications and/or services.

In some implementations, the online retailer 190 includes an online sales module 191 and an inventory database 192. In some implementations, the online retailer 190 includes a local customer sales application, such as a point-of-sale terminal within a department store. The retailer 190 may be an online service provider (e.g. a gambling website, a social networking website, a dating website, etc.) or a retailer of real and/or digital goods (e.g. clothing, music, etc.).

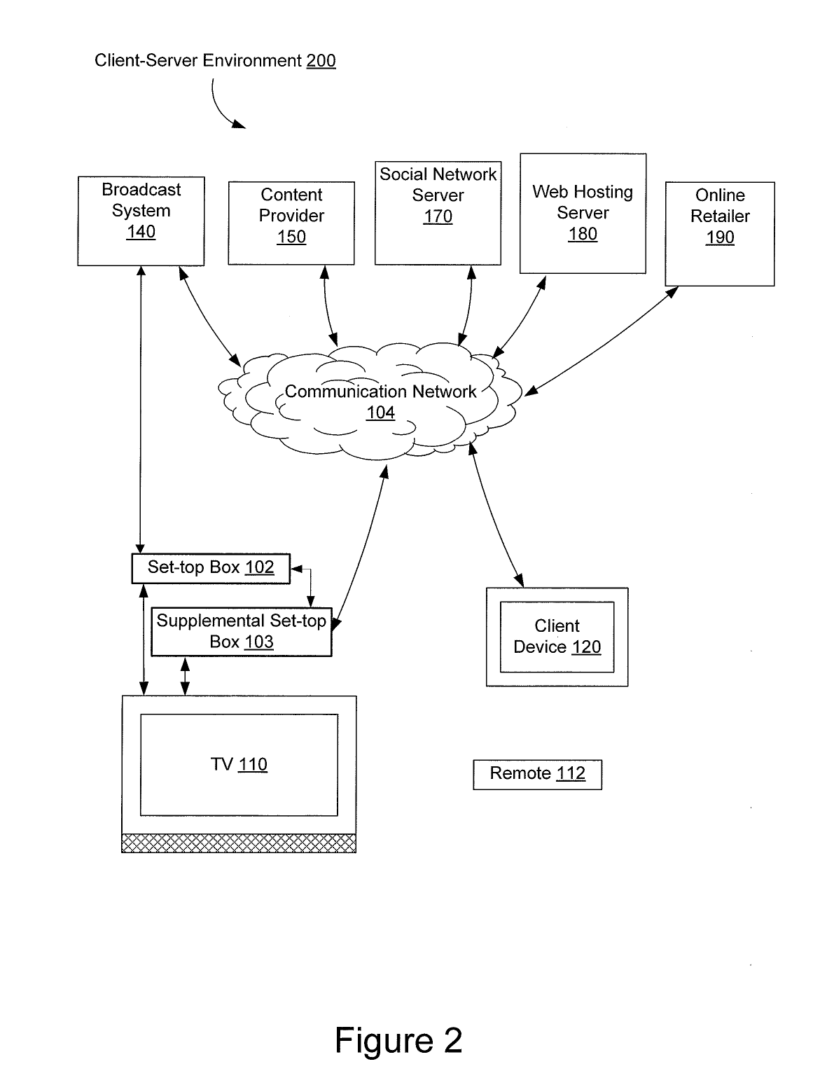

FIG. 2 is a block diagram of another example client-server environment 200. The client-server environment 200 illustrated in FIG. 2 is similar to and adapted from the client-server environment 100 illustrated in FIG. 1. Elements common to both share common reference indicia, and only the differences between the client-server environments 100, 200 are described herein for the sake of brevity.

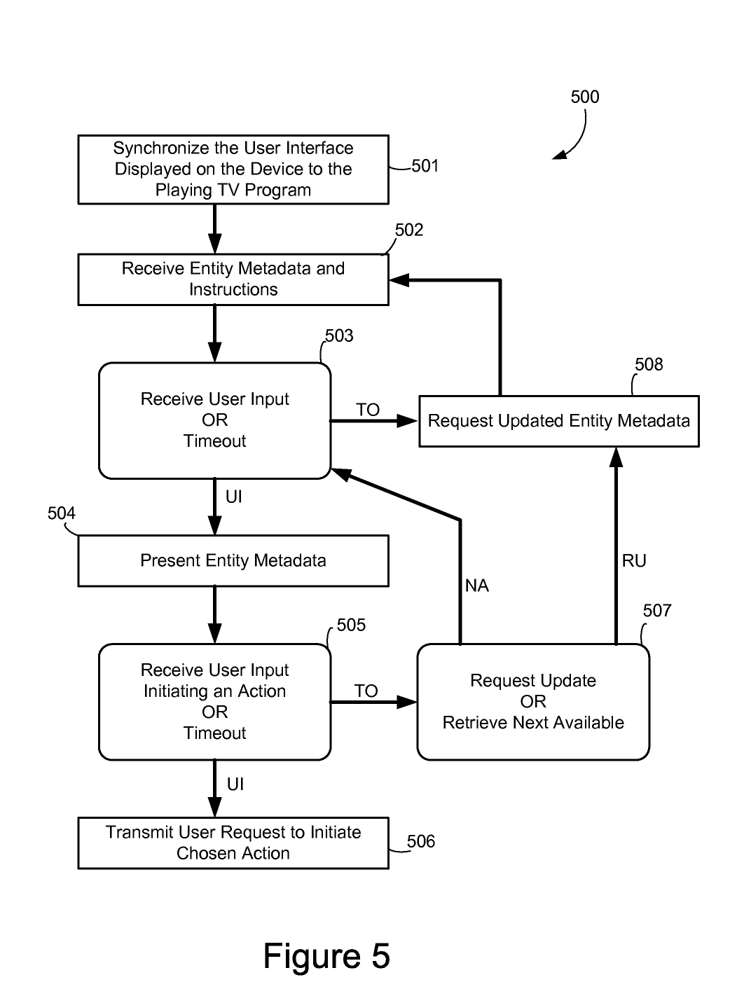

Within the client-server environment 200, the second screen client device 120 (e.g. a tablet computer or laptop, etc.), the set-top box 102, the TV 110, a supplemental set-top box 103 (e.g., an electronic device configured with Google TV functionality or a subset thereof), and a remote control 112 are provided in combination—typically within a home or office. In operation, the remote control 112 may be used to control the operation of one or more of the set-top box 102, the TV 110, and the supplemental set-top box 103. In operation, the client device 103 receives information from the set-top box 102 associated with the media content presented on the TV 110. In turn, the supplemental set-top box 103 may then communicate with any one of the media monitoring server 130, the broadcast system 140, the content provider 150, and the social network server 170 through the communication network 104. More specific details pertaining to how the supplemental set-top box 103 and/or the second screen client device 120 enables users to access one or more Internet-based media applications and/or services as a related broadcast media program is aired are described below with reference to FIGS. 5-8.

As discussed above, in some implementations, TV programs and other broadcast media programs are associated with entity metadata. The entity metadata includes at least one of instructions or a pointer that enables access to at least one Internet-based media application or service associated with the at least one identifiable entity or the program in general. An identifiable entity includes, without limitation, a person, a place, an object or an indicia of a service. For example, a TV program may be centered on a popular actor, who is an example of an identifiable entity. In turn, in some implementations, the entity metadata for that particular TV program includes instructions or a pointer to at least one of a social network account/profile, a micro-blog service account/profile, and a personal website associated with the actor. In another example, the TV program may include a reference to a new product (e.g. a car) or service (e.g. food delivery), which are also each examples of identifiable entities associated with the program. In turn, in some implementations, the entity metadata includes instructions or a pointer to at least one of a social network account/profile, a micro-blog service account/profile, and a personal website associated with the product or service. Those skilled in the art will also appreciate from the present disclosure that a TV program or other televised event is also an identifiable entity. For example, a sporting event (e.g. a basketball game) is an example of an identifiable entity, as are the teams, the players, the coaches, the announcers, and the sponsors (etc.) associated with the sporting event. In turn, in some implementations, the entity metadata for a sporting event, or any other broadcast media program, includes instructions and/or pointers for any number of identifiable entities associated with the broadcast media program.

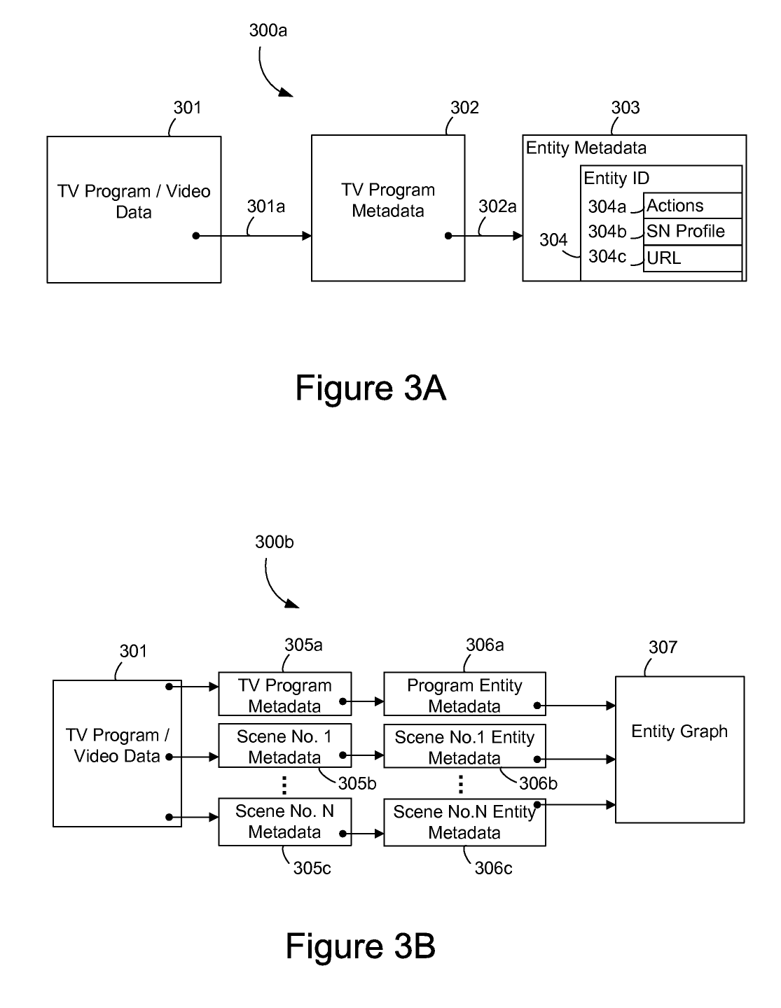

To that end, FIG. 3A is a block diagram of an example data structure 300a linking broadcast media program content with metadata including links to related Internet-based applications and/or services. More specifically, the data structure 300a includes TV program data 301, TV program metadata 302, and entity metadata 303. The TV program data 301 includes the audio and video data of the TV program, and additionally, at least one of instructions or a pointer 301a. The instructions or pointer 301a directs devices to the TV program metadata 302. Similarly, TV program metadata 302 includes at least one of instructions and a pointer 302a to the entity metadata 303. In some implementations, the TV program metadata 302 is the superset of a collection of entity metadata elements associated with the TV program data 301.

The entity metadata 303, as described above, provides instructions that direct devices to present the availability of access to one or more Internet-based applications and/or services associated with the TV program data 301. As shown for example in FIG. 3A, the entity metadata 303 includes an entity identifier 304. The entity identifier 304 then includes one or more of actions 304a (e.g. express approval, etc.), a social network profile 304b, and a website 304c associated with the entity (e.g. an actor) identified by the entity identifier 304.

FIG. 3B is a block diagram of an another example data structure 300b linking broadcast media program content with metadata including links to related Internet-based media applications and/or services. The data structure 300b illustrated in FIG. 3B is similar to and adapted from the data structure 300a illustrated in FIG. 3A. Elements common to both share common reference indicia, and only the differences between the data structures 300a, 300b are described herein for the sake of brevity. More specifically, the TV program data 301 includes a number of pointers (or instructions) to respective portions of metadata 305a, 305b, . . . 305c. For example, the metadata 305a includes metadata for the TV program as an identifiable entity. In turn, the TV program metadata 305a includes at least one of instructions or a pointer to program entity metadata 306a, which includes entity identifiers for one or more identifiable entities associated with the program as a whole (e.g. actors, sponsors, a related website, etc.). Similarly, the metadata 305b includes, for example, metadata for the first scene of the TV program as an identifiable entity. In turn, the first scene metadata 305b includes at least one of instructions or a pointer to the first scene entity metadata 306b, which includes entity identifiers for one or more identifiable entities within the first scene (e.g. the tourism website associated with a location in the first scene). The data structure 300b also includes an entity graph 307, which defines the relationships between the various entity metadata segments (i.e., 306a, 306b, . . . 306c) created for the TV program.

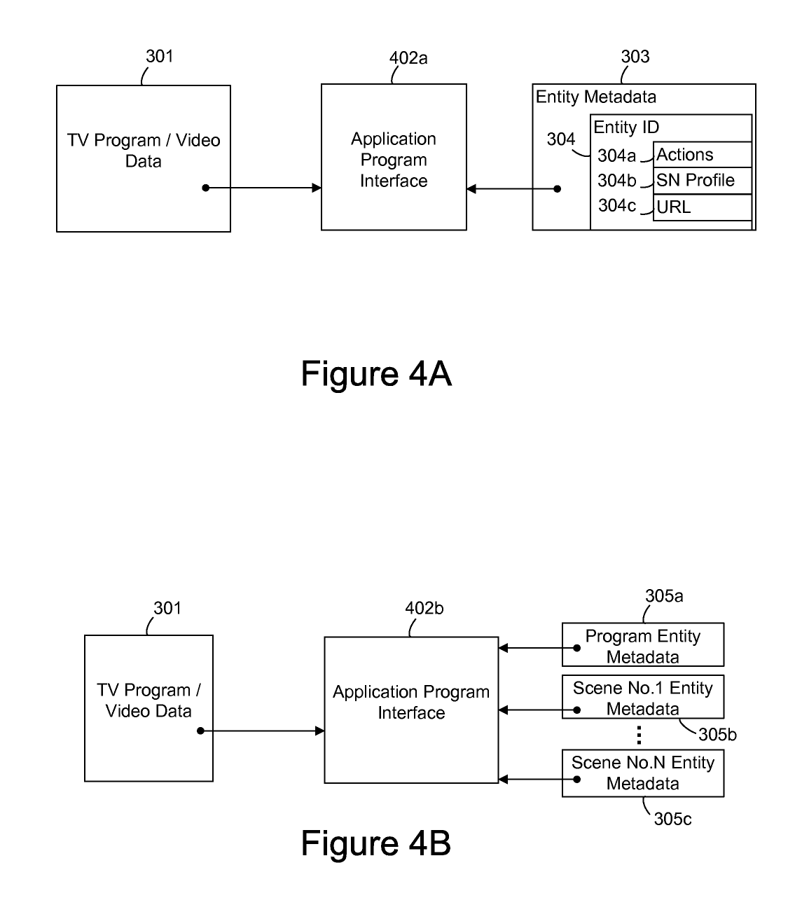

FIG. 4A is a block diagram of an example application program interface 402a linking broadcast media program content with metadata including links to related Internet-based applications and/or services. In some implementations, the application program interface 402a is a software module that operates to match TV program data 301 (i.e., the audio and video data components of a broadcast media program) to entity metadata 303. As such, the application program interface 402a includes instructions that are executed by a processor residing on any one of a server and various client devices (e.g. tablets, smart-phones, laptop computers, etc.). In some implementations, the TV program data 301 and the entity metadata 303 is included in memory on the same device as the application program interface 402a. For example, with further reference to FIGS. 1 and 2, in some implementations, the application program interface 402a, the TV program data 301 and the entity metadata 303 are all included on the supplemental set-top box 103. In some implementations, the TV program data 301 and the entity metadata 303 is included in memory on a different device accessible to the device including the application program interface. For example, with further reference to FIGS. 1 and 2, in some implementations, the application program interface 402a is included on the supplemental set-top box 103, the TV program data 301 is delivered to the set-top box 102, and the entity metadata 303 is received from the content provider 150.

FIG. 4B is a block diagram of an another example application program interface 402b linking broadcast media program content with metadata including links to related Internet-based applications and/or services. As shown in FIG. 4B the application program interface 402b links the TV program data 301 to various segments of entity metadata 305a, 305b, 305c for the same purpose as described above with reference to FIG. 4A.

FIG. 5 is a flowchart representation of an implementation of a client device method 500. In some implementations, the method 500 is performed by a set-top box associated with a cable or satellite TV provider (or the like) (e.g., the set-top box 102 of FIG. 1), and/or a supplemental set-top box (e.g., the supplemental set-top box of FIG. 2) and/or television-integrated device or system associated with an Internet-based service. Briefly, the method includes acquiring instructions and/or pointers directing the client device to an Internet-based media application and/or service associated with a broadcast media program, and presenting the availability of access to the media application and/or service while the user is watching the broadcast media program on a TV or the like.

To that end, the method 500 includes synchronizing (i.e. matching) the user interface of client device (e.g. a set-top box or a supplemental set-top box) to a TV program playing on a TV or another device (501). For example, with further reference to FIGS. 1 and 2, the TV 110 is used to present a TV program selected by a user. The TV 110 receives the audio and video signal components from the set-top box 102, which receives a corresponding signal from the broadcast system 140, the content provider 150 and/or a web-hosting service. In some implementations, the user interface of one of the set-top box 102 and the supplemental set-top box 103 is synchronized to the TV program playing on the TV 110. In some implementations, one or more of the set-top box 102 and the supplemental set-top box 103, the TV 110 is provided with instructions, storable in a non-transitory memory and executable by a processor, that, when executed by a processor, match the user interface provided by one or more of the set-top box 102 and the supplemental set-top box 103 to a particular broadcast media program having at least one identifiable entity. In some implementations, the matching process includes fingerprinting the playing TV program, communicating the fingerprint to the media monitoring server 104, and in turn, receiving a program identifier that can be used to match the user interface to the playing TV program. In some implementations, the matching process includes receiving synchronization information from one of the broadcast system 140, the content provider 150 and the web hosting service 180.

The method 500 also includes receiving entity metadata associated with the at least one identifiable entity or the program in general (502). The entity metadata includes at least one of instructions or a pointer that enables access to at least one media service associated with the at least one identifiable entity or the program in general. In some implementations, the availability of access to one or more Internet-based applications and/or services, provided by the entity metadata, is presented in response to a user input indicating that the user is interested in being presented such information. In some implementations, the input is received from one of the client device 120 and the remote control device 112. Accordingly, the method 500 includes receiving a user input or determining that a counter has breached a threshold indicating that a waiting period has expired (503). The counter threshold indicates the time during which the current entity metadata points to timely information associated with the TV program. If the user does not provide an input requesting to be presented with the availability of applications or services (“TO” path from 503), the method 500 includes transmitting a request for updated entity metadata (508). In some implementations, the request is transmitted to one of the broadcast system 140, the content provider 150 and the web hosting service 180. On the other hand, if a user input is received (“UI” path from 503), the method 500 includes presenting the entity metadata that indicates the availability of access to one or more Internet-based applications and/or services associated with the currently playing TV program. For example, with further reference to FIGS. 1 and 2, in some implementations, one of the set-top box 102 and the supplemental set-top box 103 provides the TV 110 with a displayable overlay that presents the available applications and services on a portion of the display 118.

The method 500 includes displaying the overlay until the user provides an input or a display counter threshold is breached (505). If a user input is received (“UI” path from 505), the method 500 includes transmitting an access request to one or more Internet-based applications and/or services associated with the currently playing TV program. For example, with further reference to FIGS. 1 and 2, in some implementations, one of the set-top box 102 and the supplemental set-top box 103 transmits a request to one of the web-hosting service 180, the online retailer 190 and the social network server 170. On the other hand, if the user does not provide an input requesting access to one of the available applications and services (“TO” path from 505), the method 500 includes transmitting a request for updated entity metadata or retrieving the next available set of applications and services (507). In some implementations, when new entity metadata is sought, a request for new entity metadata is transmitted to one of the broadcast system 140, the content provider 150 and the web hosting service 180, as described above with reference to the portion of the method represented by 508. In some implementations, when more entity data is available on one of the set-top box and the supplemental set-top box 103, the method circles back to the portion of the method represented by 503 from 507 so that the next available entity metadata bundle is readied for display (503).

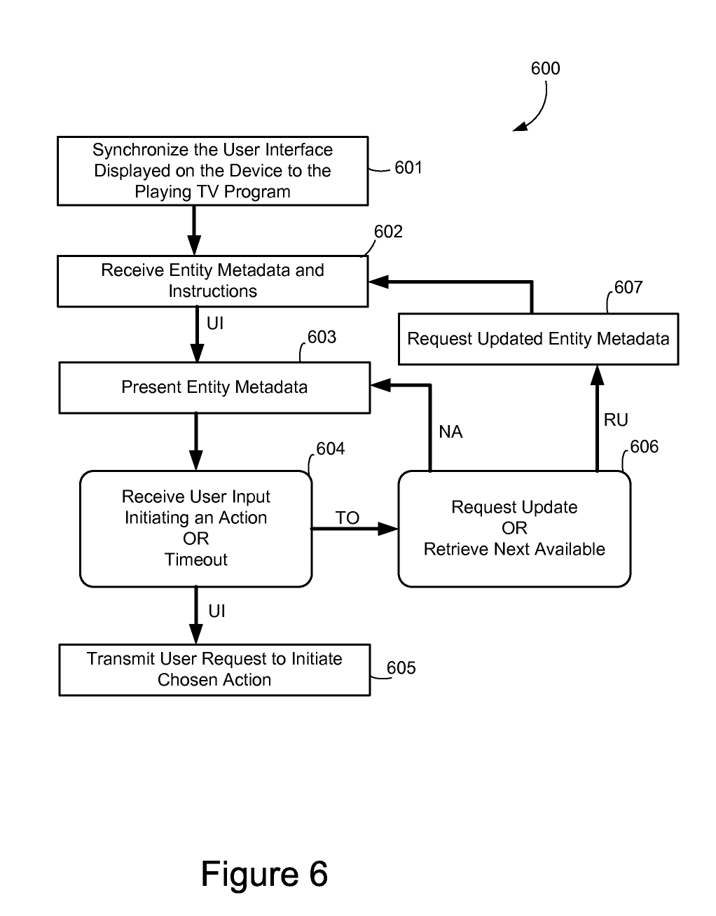

FIG. 6 is a flowchart representation of an implementation of a client device method 600. In some implementations, the method 600 is performed by at least one of a client device such as a personal computer, a laptop computer, a tablet computer, and a smart-phone (e.g., one or more client devices 120 of FIG. 1). Briefly, the method includes acquiring instructions and/or pointers directing the client device to an Internet-based media application and/or service associated with a broadcast media program, and presenting the availability of access to the media application and/or service while the user is watching the broadcast media program on a TV or the like. In some implementations, unlike the method 500, the method 600 presents the availability of the associated media applications and/or services without user selection because the method 600 is performed by a client device different from the display device presenting the broadcast media program. Consequently, the presentation of the availability of the associated media applications and/or services is not likely to directly interfere with a user's enjoyment of the playing broadcast media program.

To that end, the method 600 includes synchronizing (i.e. matching) the user interface of the client device to a TV program playing on a TV or another device (601). For example, with further reference to FIGS. 1 and 2, the TV 110 is used to present a TV program selected by a user. The TV 110 receives the audio and video signal components from the set-top box 102, which receives a corresponding signal from the broadcast system 140, the content provider 150 and/or a web-hosting service. In some implementations, the user interface of the second screen client device 120 is synchronized to the TV program playing on the TV 110. In some implementations, the second screen client device 120 is provided with instructions, storable in a non-transitory memory and executable by a processor, that, when executed by a processor, match the user interface of the second screen client device 120 to a particular broadcast media program having at least one identifiable entity. In some implementations, the matching process includes fingerprinting the playing TV program, communicating the fingerprint to the media monitoring server 104, and in turn, receiving a program identifier that can be used to match the user interface to the playing TV program. In some implementations, the second screen client device 120 records a portion of the audio and/or video of the TV program, and then transmits the recorded audio and/or video data to a server to perform the fingerprinting. In some implementations, the matching process includes receiving synchronization information from one of the broadcast system 140, the content provider 150 and the web hosting service 180.

The method 600 also includes receiving entity metadata associated with the at least one identifiable entity or the program in general (602). The entity metadata includes at least one of instructions or a pointer that enables access to at least one media service associated with the at least one identifiable entity or the program in general. The method 500 includes presenting the availability of access to one or more Internet-based applications and/or services, provided by the entity metadata, using the user interface of the second screen client device 120. Presenting the entity metadata includes indicating the availability of access to one or more Internet-based applications and/or services associated with the currently playing TV program. For example, with further reference to FIGS. 1 and 2, in some implementations, the second screen client device 120 displays the available applications and services on a portion of the display 128.

The method 600 includes displaying the available applications and/or services until the user provides an input or a display counter threshold is breached (604). If a user input is received (“UI” path from 604), the method 600 includes transmitting an access request to one or more Internet-based applications and/or services associated with the currently playing TV program. For example, with further reference to FIGS. 1 and 2, in some implementations, the second screen client device 120 transmits a request to one of the web-hosting service 180, the online retailer 190 and the social network server 170. On the other hand, if the user does not provide an input requesting access to one of the available applications and services (“TO” path from 604), the method 600 includes transmitting a request for updated entity metadata (607) or retrieving the next available set of applications and services, if such a set has been previously received. In some implementations, when new entity metadata is sought, a request for new entity metadata is transmitted to one of the broadcast system 140, the content provider 150 and the web hosting service 180. In some implementations, when more entity data is locally available on the second screen client device 120, the method circles back to the portion of the method represented by 603 so that the next available entity metadata bundle is readied for display (603).

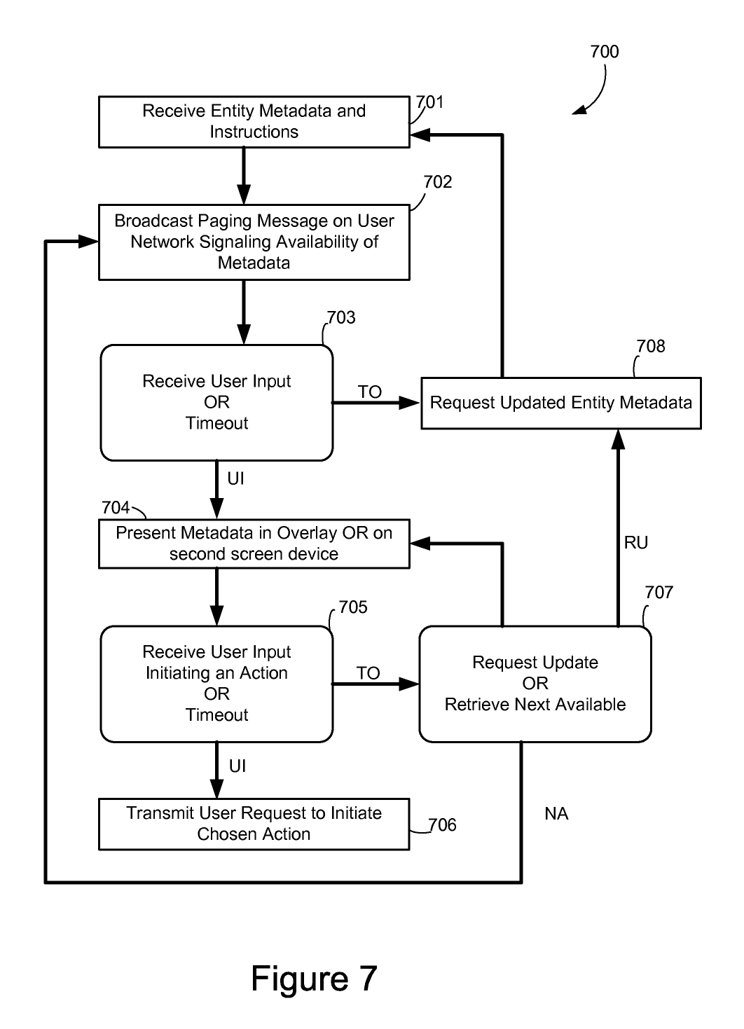

FIG. 7 is a flowchart representation of an implementation of a client device method 700. In some implementations, the method 700 is performed by a set-top box associated with a cable or satellite TV provider (or the like) (e.g., the set-top box 102 of FIG. 1), and/or a supplemental set-top box (e.g., the supplemental set-top box 103 of FIG. 2) and/or television-integrated device or system associated with an Internet-based service. Briefly, the method includes acquiring instructions and/or pointers directing the client device to an Internet-based media application and/or service associated with a broadcast media program, and presenting the availability of access to the media application and/or service while the user is watching the broadcast media program on a TV or the like.

To that end, the method 700 includes receiving entity metadata and instructions associated with the at least one identifiable entity or the program in general (701). The method 700 includes broadcasting a paging message on a user network (e.g. a local WiFi network) that signals the availability of one or more Internet-based media applications and services provided by the received entity metadata and instructions. For example, with reference to FIGS. 1 and 2, one of the set-top box 102 and the supplemental set-top box 103 transmits a paging message on a local WiFi network to which the second screen client device 120 is connected. In some implementations, the availability of access to one or more Internet-based applications and/or services, provided by the entity metadata, is presented in response to a user input indicating that the user is interested in being presented such information. In some implementations, the input is received by the second screen client device 120. Accordingly, the method 700 includes receiving a user input or a counter breaches a threshold, and thus times out (703). The counter threshold indicates the time during which the current entity metadata points to timely information associated with the TV program. If the user does not provide an input requesting to be presented with the availability of applications or services (“TO” path from 703), the method 700 includes transmitting a request for updated entity metadata (708). In some implementations, the request is transmitted from the second screen client device 120 to one of the broadcast system 140, the content provider 150, the web hosting service 180, the set-top box 102 and the supplemental set-top box 103. On the other hand, if a user input is received (“UI” path from 703), the method 700 includes presenting the entity metadata that indicates the availability of access to one or more Internet-based applications and/or services associated with the currently playing TV program (704). For example, with further reference to FIGS. 1 and 2, in some implementations, the second screen client device 120 presents the available applications and services on a portion of the display 128. In some implementations, the second screen client device 120 communicates the request to the supplemental set-top box 103, which in turn, provides the TV 110 with a displayable overlay that presents the available applications and services on a portion of the display 118.

The method 700 includes displaying the available applications and services until the user provides an input or a display counter threshold is breached (705). If a user input is received (“UI” path from 705), the method 700 includes transmitting an access request to one or more Internet-based applications and/or services associated with the currently playing TV program. For example, with further reference to FIGS. 1 and 2, in some implementations, one of the second screen client device 120 and the supplemental set-top box 103 transmits a request to one of the web-hosting service 180, the online retailer 190 and the social network server 170 (706). On the other hand, if the user does not provide an input requesting access to one of the available applications and services (“TO” path from 705), the method 700 includes transmitting a request for updated entity metadata or retrieving the next available set of applications and services (707). In some implementations, when new entity metadata is sought, a request for new entity metadata is transmitted to one of the broadcast system 140, the content provider 150 and the web hosting service 180, as described above with reference to the portion of the method represented by 708. In some implementations, when more entity data is available on one of the set-top box and the supplemental set-top box 103, the method circles back to the portion of the method represented by 703 from 707 so that the next available entity metadata bundle is readied for display (703).

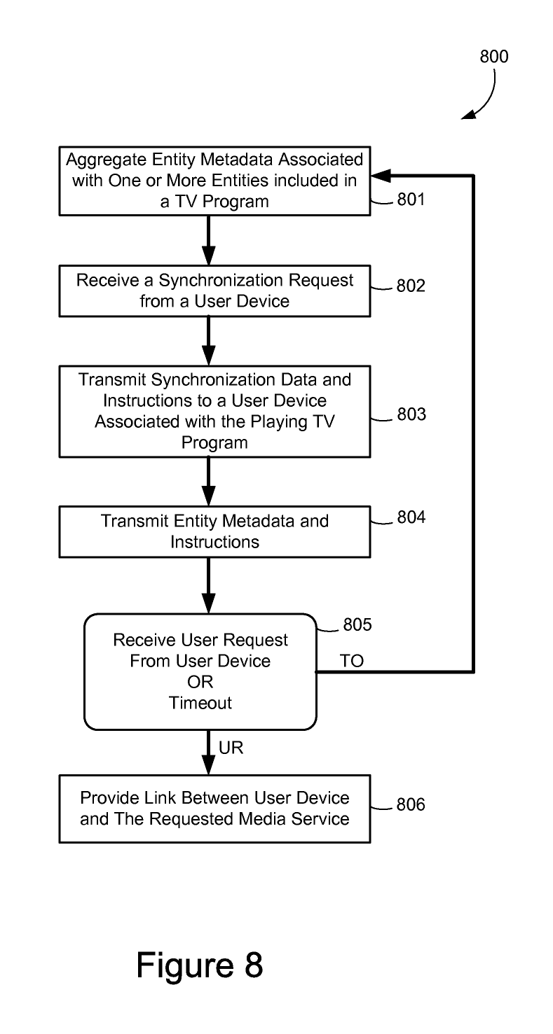

FIG. 8 is a flowchart representation of an implementation of a server system method 800. In some implementations, the method 800 is performed by a server system (e.g., one of the server systems 130, 170, 180, 190 of FIG. 1) in order to produce and deliver metadata including at least one of instructions or a pointer that enables access to at least one media application and/or service associated with the at least one identifiable entity in a broadcast media program. To that end, the method 800 includes aggregating entity metadata associated with one or more entities included in a TV program or the like (801). The method 800 includes receiving a synchronization request associated with a particular TV program or the like from a user device (802). The method 800 includes transmitting synchronization data and instructions associated with the particular TV program or the like to the user device in response to receiving the synchronization request (803). The method 800 includes transmitting entity metadata and instructions to the client device (804). In some implementations, the entity metadata and instructions are transmitted in response to receiving a confirmation that the user device has successfully utilized the synchronization data and instructions.

Subsequently, the method 800 includes receiving a user request from the client device or determining that a counter has breached a threshold indicating that a waiting period has expired (805). If a user request is not received before the counter threshold has been breached (“TO” path from 805), the method 800 includes circling back to the portion of the method represented by 801. On the other hand, if a user request is received in time (“UR” path from 805), the method 800 includes providing a link between the user device and the requested media application or service.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A system enabling device interaction with media services associated with identifiable entities within a broadcast media program, the system including instructions, storable in a non-transitory memory and executable by a processor, that, when executed cause the processor to:
automatically identify a particular broadcast media program being presented in proximity to a user, wherein the particular broadcast media program includes at least one identifiable entity;
match a user interface of a user device with the identified particular broadcast media program, including executing an application on the user device associated with the particular broadcast media program;
receive at the application entity metadata associated with the at least one identifiable entity, wherein the entity metadata includes at least one of instructions or a pointer that enables access to at least one media service associated with the at least one identifiable entity; and
present by the application availability of access to the at least one media service associated with the at least one identifiable entity.

2. The system of claim 1, further comprising instructions that, when executed cause the processor to receive a user input, wherein the input is indicative of at least the initiation of attempting to access media services associated with the particular broadcast media program, and wherein the instructions to match the user interface with the particular broadcast media program are processed in response to receiving the user input.

3. The system of claim 1, further comprising instructions that, when executed cause the processor to receive a user input, wherein the input is indicative of at least the initiation of attempting to access media services associated with the particular broadcast media program, and wherein the instructions to present the availability of access to the at least one media service are processed in response to receiving the user input.

4. The system of claim 1, further comprising instructions that, when executed cause the processor to transmit a user selection associated with the at least one media service presented on a user interface.

5. The system of claim 1, further comprising instructions that, when executed cause the processor to transmit a request for updated entity metadata.

6. The system of claim 1, wherein the particular broadcast media program includes at least one of a movie, a television show, a commercial, radio show, a video file, or an audio file.

7. The system of claim 1, wherein the at least one identifiable entity includes a person, a place, an object or an indicia of a service.

8. The system of claim 7, wherein the object includes a consumer product.

9. The system of claim 1, wherein the service includes at least one of an internet-based service or an action by a service provider.

10. The system of claim 1, wherein the at least one media service is related to a social networking service.

11. The system of claim 1, wherein the system comprises a client device associated with a television, and the entity metadata is presented as a screen overlay.

12. The system of claim 1, wherein the system comprises a television, and the entity metadata is presented as a screen overlay.

13. The system of claim 1, wherein the system comprises at least one of a laptop computer, a tablet computer or a smart phone, and the entity metadata is presented in a web-browser.

14. The system of claim 1, wherein the system comprises at least one of a laptop computer, a tablet computer or a smart phone, and the entity metadata is presented in an application interface.

15. The system of claim 1, wherein the entity metadata comprises a dataset that includes the dataset comprising the broadcast media content.

16. The system of claim 1, wherein the entity metadata comprises a dataset that is distinct from the dataset comprising the broadcast media content.

17. The system of claim 1, wherein the entity metadata includes relationship information linking at least two entities.

18. A computer-implemented method of enabling interaction with media services associated with identifiable entities within a broadcast media program from a device including a non-transitory memory and a processor, the method comprising:
at a computer system with one or more processors and memory:
automatically aggregating entity metadata associated with one or more identifiable entities within the broadcast media program, wherein the entity metadata includes at least one of instructions or a pointer that enables access to at least one media service associated with the at least one identifiable entity;
transmitting synchronization instructions associated with the broadcast media program and the entity metadata associated with one or more identifiable entities within the broadcast media program to the device;
providing an interface by which users can request presentation of the entity metadata; and
facilitating access to at least one media service associated with the at least one identifiable entity in response to receiving a request from a user device.

19. The system of claim 1, further comprising instructions that, when executed, cause the processor to match the user interface of a user device with the identified particular broadcast media program, and receive at the application entity metadata associated with the at least one identifiable entity without any user interactions.

20. A method, comprising:
at a computer system with one or more processors and memory:
automatically identifying a particular broadcast media program being presented in proximity to a user, wherein the particular broadcast media program includes at least one identifiable entity;
synchronizing a user interface of a user device with the identified particular broadcast media program, including executing an application on the user device associated with the particular broadcast media program;
transmitting entity metadata associated with the at least one identifiable entity to the application, wherein the entity metadata includes at least one of instructions or a pointer that enables access to at least one media service associated with the at least one identifiable entity; and
transmitting instructions to the application to cause the application to present availability of access to the at least one media service associated with the at least one identifiable entity.
